(19) United States
(12) Patent Application Publication
(10) Pub. No.: US 2022/0280272 A1
(43) Pub. Date: Sep. 8, 2022

(54) DENTAL NOZZLE DEVICE

(71) Applicant: Medicom Group Inc., Pointe-Claire (CA)

(72) Inventors: F. S. Kwong, Sham Shui Po (HK); W. Y. Tam, Tung Chung Lantau island. N.T (HK)

(73) Assignee: Medicom Group Inc., Pointe-Claire (CA)

(21) Appl. No.: 17/194,805

(22) Filed: Mar. 8, 2021

(51) Int. Cl. A61C 17/02; A61C 17/022

(52) U.S. Cl. CPC A61C 17/0202; A61C 17/0217; A61C 17/022

(57) ABSTRACT

An air-water syringe device created with a cylinder enclosing separate water and air channels designed to allow the air channel to be diverted by a minimum of 2 guide vanes at the exit of the device to direct the water flow as desired by the user. A minimum of 1 air channel is disclosed which encompasses the entire inner circumference of the cylinder of the device. The inclination of the guide vanes can be designed with desired angles but typically the angle of inclination of the guide vanes is between a range of 46° and 28°. The device can be designed with a flexible section and with finger grips as desired.

### BACKGROUND

Current air-water syringes on the market are known to allow a dentist to irrigate and dry the mouth on every patient for every procedure. These known devices are configured and operate in different ways. The device disclosed and claimed provides a novel, more efficient and easier to operate disposable air-water syringe design.

### SUMMARY

Disclosed are dental nozzle devices or air-water single piece syringes which include a double tube design. The water channel is surrounded by an air channel at the inlet of the device. The single air channel is then divided into 3 air outlets by ways of the guide vanes at the tip end of the device. The spray angle and shape of the guide vane allow for spiral and conical spray angle and micro fine mist. The flexible band area allows dentist to adjust angle of device without affecting the water and air flow.

### BRIEF DESCRIPTION OF THE DRAWINGS

For a better understanding of the embodiments described herein and to show more clearly how they may be carried into effect, reference will now be made, by way of example only, to the following drawings.

FIG. 1 illustrates a perspective of the air-water syringe device for the adaptor model.

FIG. 2 depicts a perspective for a slim model of the air-water syringe device.

FIG. 3 illustrates the side view of the air-water syringe device.

FIG. 4 illustrates cross section C-C of FIG. 3 for the outlet of the air-water syringe device.

FIG. 5 illustrates cross section A-A of FIG. 3 showing the inside cylinder body.

FIG. 6 illustrates cross section B-B of FIG. 3 for the inlet of the air-water syringe device.

FIG. 7 illustrates a blown-up view of the outlet of cross section C-C of FIG. 3 for the outlet of the air-water syringe device.

It will be appreciated that for simplicity and clarity of illustration, elements shown in the figures have not necessarily been drawn to scale. For example, the dimensions of some of the elements may be exaggerated relative to other elements for clarity.

### PARTS LIST

Single piece syringe design containing:
1. Body Cylinder
2. Water Channel
3. Air Channel
4. Water outlet
5. Guide vane
6. Water inlet
7. Finger grip (on adaptor design)
8. Flexible section
9. Air Inlet
10. Air Outlet
11. Inlet End
12. Outlet/Tip End

### DETAILED DESCRIPTION

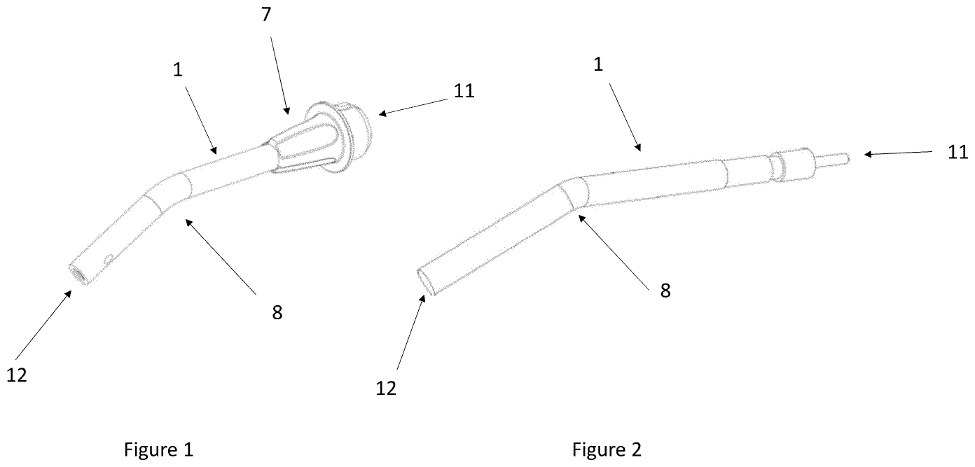

As depicted on FIG. 1 the air-water syringe device for the adaptor model includes the body cylinder (1) extending from the inlet end (11) to the outlet/tip end (12) with the finger grip (7), and a flexible section (8) on the body cylinder (1). FIG. 2 depicts a perspective for a slim model of the air-water syringe device. The working principal is the same for the adaptor and the slim version. The only difference is they are designed to fit with a different model of handpiece. The adaptor type requires a connector between the handpiece and the air-water syringe. The direction for use is to plug and lock to the handpiece by user.

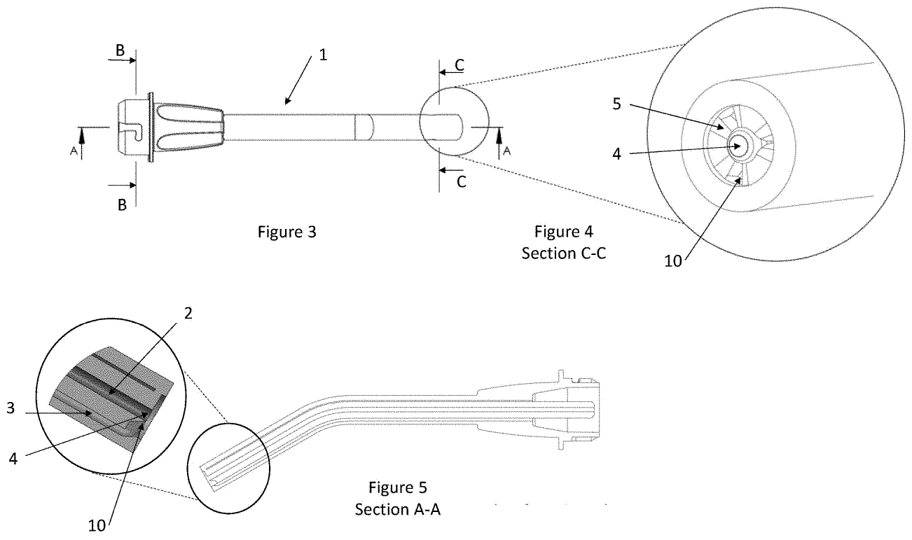

FIG. 3 illustrates the side view of the air-water syringe device. The air-water syringe device shown on FIGS. 4, 5 and 6 depicts the inside configuration. FIG. 4 illustrates cross section C-C of FIG. 3 for the outlet of the air-water syringe device including the water outlet (4), the guide vanes (5) and the air outlet (10). FIG. 5 illustrates cross section A-A of FIG. 3 showing the inside cylinder body with the water channel (2), air channel (3)) water outlet (4), and air outlet 10).

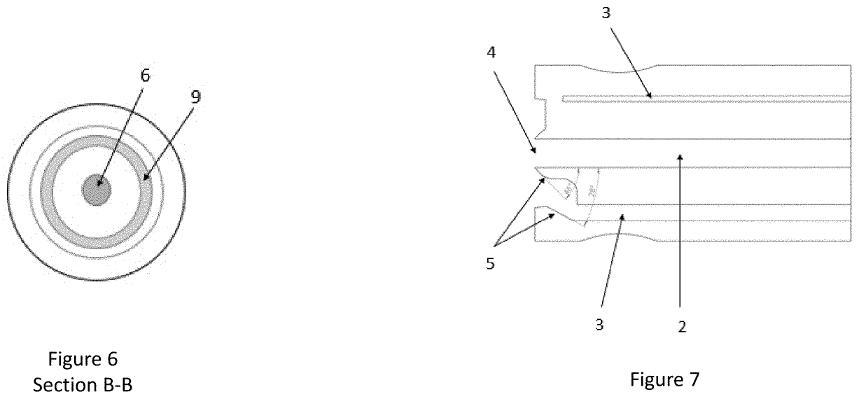

FIG. 6 illustrates cross section B-B of FIG. 3 for the inlet of the air-water syringe device depicting the water inlet (6) and the air inlet (9). The water channel (2) reaches the tip of the device with one water outlet (4). The air flow gets separated into 3 outlets (10) at the tip end (12) of the device by way of the guide vanes (5). As shown on the figure the air channel (3) starts at the air inlet (9) encompassing the whole inner circumference of the channel from the inlet end of the cylinder to the guide vanes at the vanes at the air outlet. At the air outlet (10) the air in the air channel (3) is diverted by the guide vanes (5) to exit in three outlets (10) at the tip end (12) of the device. The device is not limited to requiring exactly 3 air outlets and 1 water inner tube (2). The device can have a multiple channels/tubes for the air and for the water.

FIG. 7 illustrates a blown-up view of the outlet of cross section C-C of FIG. 3 for the outlet of the air-water syringe device. It shows the spray angles of 46° and 28° as well as the guide vanes (5) of the device to precisely control air and water mist. These angles and inclination of the guide vanes (5) were chosen during the design of experiment for the best spray effect. The device is not limited to have these angles; any angles or guide vane inclination in the range of 46° and 28° can also be applied to this device.

The device can be manufactured in one piece using injection molding and as such, there is no assembly. This device can also have a multi-piece design requiring assembly. In one embodiment the material used is white polypropylene (PP SM498) and the texture is smooth. But the material used, the color, and the finish can be selected according to particular requirements and preference.

The disclosed multichannel syringe is primarily for dental applications utilizing air and water. But the multichannel design can be adapted for use in other applications and with other types of gas and liquid.

FIGS. 1 and 2 also shows the flexible section (8). One method to achieve flexible bending is to add an additional step following the injection molding and before the material has cooled. The device is bent to an adjustable angle. The flexibility comes from the Polypropylenes physical properties and its temperature after injection molding but before completely cooling off.

Disclosed is an air-water syringe comprising: a cylinder with an inlet end and an outlet end; a minimum of 1 water channel traversing from the inlet end to the outlet end; a minimum of 1 air channel traversing from the inlet end to the outlet end; and a minimum of 2 guide vanes at an end of the air channel located at the outlet end of the cylinder.

In one embodiment the air-water syringe the air channel encompasses the entire inner circumference of the channel from the inlet end of the cylinder to the minimum of 2 guide vanes at the outlet end of the cylinder.

A disclosed embodiment for the air-water syringe can include the minimum of 1 air channel which is diverted by the guide vanes to exit in three outlets.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

We claim:

1. An air-water syringe comprising:
a cylinder with an inlet end and an outlet end;
a minimum of 1 water channel traversing from the inlet end to the outlet end;
a minimum of 1 air channel traversing from the inlet end to the outlet end; and
a minimum of 2 guide vanes at an end of the air channel located at the outlet end of the cylinder.

2. An air-water syringe according to claim 1 wherein the minimum of 1 air channel encompasses an entire inner circumference of the minimum of 1 channel from the inlet end of the cylinder to the minimum of 2 guide vanes at the outlet end of the cylinder.

3. An air-water syringe according to claim 2 wherein the minimum of 1 air channel is diverted by the minimum of 2 guide vanes to exit the air-water syringe in three outlets.

4. An air-water syringe according to claim 3 wherein an inclination of the minimum of 2 guide vanes is between a range of 46° and 28°.

5. An air-water syringe according to claim 4 further comprising a flexible section of the air-water syringe.

6. An air-water syringe according to claim 2 further comprising a flexible section of the air-water syringe.

7. An air-water syringe according to claim 2 wherein a material used is polypropylene.

8. An air-water syringe according to claim 2 further comprising a finger grip.

9. An air-water syringe according to claim 1 wherein the minimum of 1 air channel is diverted by the minimum of 2 guide vanes to exit the air-water syringe in three outlets.

10. An air-water syringe according to claim 9 further comprising a flexible section of the air-water syringe.
